(19) United States
(12) Patent Application Publication
(10) Pub. No.: US 2022/0052951 A1
(43) Pub. Date: Feb. 17, 2022

(54) Congestion Information Collection Method and System, Related Device, and Computer Storage Medium

(71) Applicant: Huawei Technologies Co., Ltd., Shenzhen (CN)

(72) Inventors: Xuesong Geng, Beijing (CN); Tianran Zhou, Beijing (CN); Guoyi Chen, Beijing (CN)

(21) Appl. No.: 17/514,567

(22) Filed: Oct. 29, 2021

Related U.S. Application Data
(63) Continuation of application No. PCT/CN2020/087357, filed on Apr. 28, 2020.

(30) Foreign Application Priority Data
Apr. 30, 2019 (CN) 201910370837.8

(51) Int. Cl. H04L 12/803

(52) U.S. Cl. CPC H04L 47/122

(57) ABSTRACT

This application provides a congestion information collection method and a related device. The method includes: A first connection node receives a first packet, obtains congestion information of a segment link including the first connection node, and records the congestion information in a parameter field corresponding to the first connection node in the first packet. By encapsulating a plurality of parameter fields that can be used to record congestion information into a packet, a node on a forwarding path can record congestion information of a plurality of segment links of a transmission path of the packet. In this way, a source node can plan a transmission path of a new packet based on congestion information of each segment link, or a node that generates a packet reduces a packet sending rate when the sent packet needs to pass through a congested node.

### CROSS-REFERENCE TO RELATED APPLICATIONS

This application is a continuation of International Application No. PCT/CN2020/087357, filed on Apr. 28, 2020, which claims priority to Chinese Patent Application No. 201910370837.8 filed on Apr. 30, 2019. The disclosures of the aforementioned applications are hereby incorporated by reference in their entireties.

### TECHNICAL FIELD

The present invention relates to the field of communications technologies, and in particular, to a congestion information collection method and system, a related device, and a computer storage medium.

### BACKGROUND

Network congestion, a phenomenon of network overload, means that incoming traffic exceeds storage and forwarding capabilities of a network node when a large number of packets pass through the network node at the same time, causing a decrease in throughput, an increase in delay, and packet loss. Severe network congestion may lead to congestive collapse, and cause interruption of network communication services.

Currently, whether network congestion occurs or how severe is the congestion is determined based on path congestion information that is recorded at a granularity of paths. Accordingly, operations responding to the congestion are also performed based on congestion information recorded at a granularity of paths, and consequently a new forwarding path for a sending node to send a new packet may still include a congested node. Currently, because congestion information of each path is collected separately, congestion information of overlapping links or intersected nodes cannot be shared when there are overlapping links or intersected nodes on different paths. As a result, efficiency of collecting network congestion information is relatively low.

### SUMMARY

Embodiments of the present invention disclose a congestion information collection method. By encapsulating a plurality of parameter fields that can be used to record congestion information into a packet, a node on a forwarding path of the packet can record congestion information of a plurality of segment links of a transmission path of the packet. Further, a source node can plan a transmission path of a new packet based on congestion information of each segment link, to avoid a congested link in the third congestion information table or a link whose congestion degree is greater than a second preset threshold.

According to a first aspect, this application provides a network congestion information collection method. The method includes: a first connection node receives a first packet, where a forwarding path of the first packet includes a plurality of connection nodes, the forwarding path is divided by the plurality of connection nodes into a plurality of segment links, the first connection node is any one of the plurality of connection nodes, the first packet includes a plurality of parameter fields respectively corresponding to the plurality of connection nodes, and each of the plurality of parameter fields is used to record congestion information of a segment link; the first connection node obtains congestion information of a segment link including the first connection node; and the first connection node records the congestion information in the parameter field corresponding to the first connection node in the first packet.

According to the congestion information collection method provided in this application, a plurality of parameter fields that can be used to record congestion information are encapsulated into a packet, so that congestion information of a plurality of segment links of a transmission path of a packet can be recorded during transmission of the packet. Then, a target node can feed back, to a source node, the congestion information of the plurality of segment links recorded in the packet, so that the source node can maintain a file that records the congestion information of the plurality of segment links in a network. When sending a new packet, the source node can plan a transmission path of the new packet based on congestion information of each segment link. This can avoid the following case in which a specific location where congestion occurs cannot be located when a network congestion status is recorded based on the entire transmission path, and consequently the new packet cannot bypass the congested location.

In a specific implementation, the segment link including the first connection node is a segment link between the first connection node and a next connection node on the forwarding path of the first packet. The obtaining congestion information of a segment link including the first connection node includes: the first connection node obtains address information of a second connection node, where the second connection node is a next connection node on the forwarding path of the first packet; the first connection node determines, based on the address information of the second connection node, an egress port through which the first connection node forwards the first packet; and the first connection node obtains a congestion degree of the egress port, and uses the congestion degree as the congestion information of the segment link including the first connection node.

In a specific implementation, that the first connection node obtains a congestion degree of the egress port, and uses the congestion degree as the congestion information of the segment link including the first connection node includes: the first connection node obtains the congestion degree of the egress port; and when the congestion degree of the egress port is greater than a first preset threshold, the first connection node determines that a link is congested between the first connection node and the second connection node, and uses the information that the link is congested between the first connection node and the second connection node as the congestion information; or when the congestion degree of the egress port is less than or equal to the first preset threshold, the first connection node determines that a link is not congested between the first connection node and the second connection node, and uses the information that the link is not congested between the first connection node and the second connection node congestion information as the congestion information.

In a specific implementation, the segment link including the first connection node is a segment link between the first connection node and a previous connection node on the forwarding path of the first packet. The obtaining congestion information of a segment link including the first connection node includes: the first connection node obtains congestion information in a congestion field, where the congestion information in the congestion field indicates a congestion status of a link between the first connection node and a third connection node, the third connection node is a previous connection node on the forwarding path, and the congestion information in the congestion field is recorded by a forwarding node located on a segment link between the third connection node and the first connection node or recorded by the third connection node; and the first connection node uses the congestion information in the congestion field as the congestion information of the segment link.

In a specific implementation, the method further includes: the first connection node obtains address information of a next node on the forwarding path of the first packet; the first connection node determines, based on the address information of the next node, an egress port through which the first connection node forwards the first packet; and the first connection node obtains a congestion degree of the egress port, and records the congestion degree in the congestion field.

In a specific implementation, after the first connection node obtains the congestion information in the congestion field, the method further includes: that the first connection node obtains a congestion degree of the egress port, and records the congestion degree in the congestion field includes: the first connection node obtains the congestion degree of the egress port; and when the congestion degree is greater than a first preset threshold, the first connection node determines that a link is congested between the first connection node and the next node, and records the information that the link is congested between the first connection node and the next node in the congestion field; or the first connection node obtains the congestion degree of the egress port; and when the congestion degree is less than or equal to the first preset threshold, the first connection node determines that a link is not congested between the first connection node and the next node, and records the information that the link is not congested between the first connection node and the next node in the congestion field.

In a specific implementation, the first packet includes a plurality of segment identifier fields, and each of the plurality of segment identifier fields includes address information and a parameter field that are corresponding to a connection node on the forwarding path.

In a specific implementation, that the first connection node records the congestion information in a parameter field corresponding to the first connection node in the first packet includes: the first connection node obtains address information of the first connection node; the first connection node determines, based on the address information of the first connection node and address information in the plurality of segment identifier fields, a segment identifier field corresponding to the first connection node in the first packet; and the first connection node records the congestion information in a parameter field of a segment identifier field corresponding to the first connection node in the first packet.

According to a second aspect, this application provides a network congestion information collection method. The method includes: a source node sends a first packet to a target node, where a forwarding path of the first packet includes a plurality of connection nodes, the forwarding path is divided by the plurality of connection nodes into a plurality of segment links, the first packet includes a plurality of parameter fields, each of the plurality of parameter fields is used to record congestion information of a segment link, and the congestion information is recorded by a connection node on the forwarding path in a process of forwarding the first packet; the source node receives a congestion information record, where the congestion information record is sent by the target node after receiving the first packet, and the congestion information record includes congestion information that is of each segment link and that is recorded in the first packet; and the source node updates locally recorded congestion information based on the received congestion information record.

In a specific implementation, the source node obtains a destination address of a second packet.

The source node plans a forwarding path of the second packet based on locally updated congestion information, to avoid a segment link whose congestion degree is greater than a second preset threshold or a congested link in a planning process.

In a specific implementation, before the source node sends the first packet to the target node, the method further includes:

The source node encapsulates a plurality of segment identifier fields into the first packet, where each of the plurality of segment identifier fields includes address information corresponding to one connection node on the forwarding path and the parameter field.

According to a third aspect, an embodiment of this application provides a congestion information collection apparatus. The apparatus includes: a communications unit, configured to receive a first packet, where a forwarding path of the first packet includes a plurality of connection nodes, the forwarding path is divided by the plurality of connection nodes into a plurality of segment links, the congestion information collection apparatus is any one of the plurality of connection nodes, the first packet includes a plurality of parameter fields respectively corresponding to the plurality of connection nodes, and each of the plurality of parameter fields is used to record congestion information of a segment link; and a processing unit, configured to obtain congestion information of a segment link including the congestion information collection apparatus, and record the congestion information in a parameter field corresponding to the congestion information collection apparatus in the first packet.

In a specific implementation, the segment link including the congestion information collection apparatus is a segment link between the congestion information collection apparatus and a next connection node on the forwarding path of the first packet, and the processing unit is specifically configured to: obtain address information of a second connection node, where the second connection node is a next connection node on the forwarding path of the first packet; determine, based on the address information of the second connection node, an egress port through which the congestion information collection apparatus forwards the first packet; and obtain a congestion degree of the egress port, and use the congestion degree as the congestion information of the segment link including the congestion information collection apparatus.

In a specific implementation, the processing unit is specifically configured to: obtain the congestion degree of the egress port; and when the congestion degree of the egress port is greater than a first preset threshold, determine that a link is congested between the congestion information collection apparatus and the second connection node, and use the information that the link is congested between the congestion information collection apparatus and the second connection node as the congestion information; or when the congestion degree of the egress port is less than or equal to the first preset threshold, determine that the link is not congested between the congestion information collection apparatus and the second connection node, and use the information that the link is not congested between the congestion information collection apparatus and the second connection node as the congestion information.

In a specific implementation, the segment link including the congestion information collection apparatus is a segment link between the congestion information collection apparatus and a previous connection node on the forwarding path of the first packet, and the processing unit is specifically configured to: obtain congestion information in a congestion field, where the congestion information in the congestion field indicates a congestion status of a link between the congestion information collection apparatus and a third connection node, the third connection node is a previous connection node on the forwarding path, and the congestion information in the congestion field is recorded by a forwarding node located on a segment link between the third connection node and the congestion information collection apparatus or recorded by the third connection node; and use the congestion information in the congestion field as the congestion information of the segment link.

In a specific implementation, after the first connection node obtains the congestion information in the congestion field, the processing unit is further configured to: obtain address information of a next node on the forwarding path of the first packet; determine, based on the address information of the next node, an egress port through which the congestion information collection apparatus forwards the first packet; and obtain the congestion degree of the egress port, and record the congestion degree in the congestion field.

In a specific implementation, the processing unit is specifically configured to: obtain the congestion degree of the egress port; and when the congestion degree is greater than a first preset threshold, determine that a link is congested between the congestion information collection apparatus and the next node, and record the information that the link is congested between the congestion information collection apparatus and the next node in the congestion field; or obtain the congestion degree of the egress port; and when the congestion degree is less than or equal to the first preset threshold, determine that the link is not congested between the congestion information collection apparatus and the next node, and record the information that the link is not congested between the congestion information collection apparatus and the next node in the congestion field.

In a specific implementation, the first packet includes a plurality of segment identifier fields, and each of the plurality of segment identifier fields includes address information and a parameter field that are corresponding to a connection node on the forwarding path.

In a specific implementation, the processing unit is specifically configured to: obtain address information of the congestion information collection apparatus; determine, based on the address information of the congestion information collection apparatus and address information in the plurality of segment identifier fields, a segment identifier field corresponding to the congestion information collection apparatus in the first packet; and record the congestion information in a parameter field of the segment identifier field corresponding to the congestion information collection apparatus in the first packet.

According to a fourth aspect, an embodiment of this application provides a congestion information collection apparatus. The apparatus includes: a communications unit, configured to send a first packet to a target node, where a forwarding path of the first packet includes a plurality of connection nodes, the forwarding path is divided by the plurality of connection nodes into a plurality of segment links, the first packet includes a plurality of parameter fields, each of the plurality of parameter fields is used to record congestion information of a segment link, and the congestion information is recorded by a connection node on the forwarding path in a process of forwarding the first packet, where the communications unit is further configured to a congestion information record, where the congestion information record is sent by the target node after receiving the first packet, and the congestion information record includes congestion information that is of each segment link and that is recorded in the first packet; and a processing unit, configured to update locally recorded congestion information based on the received congestion information record.

In a specific implementation, the processing unit is specifically configured to: obtain a destination address of a second packet; and plan a forwarding path of the second packet based on locally updated congestion information, to avoid a segment link whose congestion degree is greater than a second preset threshold or a congested link in a planning process.

In a specific implementation, before the communications unit sends the first packet to the target node, the processing unit is further configured to: encapsulate a plurality of segment identifier fields into the first packet, where each of the plurality of segment identifier fields includes address information corresponding to one connection node on the forwarding path and the parameter field.

According to a fifth aspect, an embodiment of this application provides a congestion information collection system. The system includes a source node, a target node, and a plurality of connection nodes.

The source node sends a first packet to the target node, where a forwarding path of the first packet includes a plurality of connection nodes, the forwarding path is divided by the plurality of connection nodes into a plurality of segment links, the first packet includes a plurality of parameter fields respectively corresponding to the plurality of connection nodes, each of the plurality of parameter fields is used to record congestion information of a segment link, and the congestion information is recorded by a connection node on the forwarding path in a process of forwarding the first packet.

A first connection node receives the first packet, where the first connection node is any one of the plurality of connection nodes.

The first connection node obtains congestion information of a segment link including the first connection node, and records the congestion information in a parameter field corresponding to the first connection node in the first packet.

The source node receives a congestion information record, where the congestion information record is sent by the target node after receiving the first packet, and the congestion information record includes congestion information that is of each segment link and that is recorded in the first packet.

The source node updates locally recorded congestion information based on the received congestion information record.

In a specific implementation, the segment link including the first connection node is a segment link between the first connection node and a next connection node on the forwarding path of the first packet. That the first connection node obtains congestion information of a segment link including the first connection node includes: the first connection node obtains address information of a second connection node, where the second connection node is a next connection node on the forwarding path of the first packet; the first connection node determines, based on the address information of the second connection node, an egress port through which the first connection node forwards the first packet; and the first connection node obtains a congestion degree of the egress port, and uses the congestion degree as the congestion information of the segment link including the first connection node.

In a specific implementation, that the first connection node obtains a congestion degree of the egress port, and uses the congestion degree as the congestion information of the segment link including the first connection node includes: the first connection node obtains the congestion degree of the egress port; and when the congestion degree of the egress port is greater than a first preset threshold, the first connection node determines that a link is congested between the first connection node and the second connection node, and uses the information that the link is congested between the first connection node and the second connection node as the congestion information; or when the congestion degree of the egress port is less than or equal to the first preset threshold, the first connection node determines that a link is not congested between the first connection node and the second connection node, and uses the information that the link is not congested between the first connection node and the second connection node congestion information as the congestion information.

In a specific implementation, the segment link including the first connection node is a segment link between the first connection node and a previous connection node on the forwarding path of the first packet. That the first connection node obtains congestion information of a segment link including the first connection node includes: the first connection node obtains congestion information in a congestion field, where the congestion information in the congestion field indicates a congestion status of a link between the first connection node and a third connection node, the third connection node is a previous connection node on the forwarding path, and the congestion information in the congestion field is recorded by a forwarding node located on a segment link between the third connection node and the first connection node or recorded by the third connection node; and the first connection node uses the congestion information in the congestion field as the congestion information of the segment link.

In a specific implementation, after the first connection node obtains congestion information in the congestion field, the first connection node is further configured to following operations: obtain address information of a next node on the forwarding path of the first packet; determine, based on the address information of the next node, an egress port through which the first connection node forwards the first packet; and obtain a congestion degree of the egress port, and records the congestion degree in the congestion field.

In a specific implementation, that the first connection node obtains a congestion degree of the egress port, and records the congestion degree in the congestion field comprises: the first connection node obtains the congestion degree of the egress port; and when the congestion degree is greater than a first preset threshold, the first connection node determines that a link is congested between the first connection node and the next node, and records the information that the link is congested between the first connection node and the next node in the congestion field; or the first connection node obtains the congestion degree of the egress port; and when the congestion degree is less than or equal to the first preset threshold, the first connection node determines that a link is not congested between the first connection node and the next node, and records the information that the link is not congested between the first connection node and the next node in the congestion field.

In a specific implementation, the source node encapsulates a plurality of segment identifier fields into the first packet, where each of the plurality of segment identifier fields includes address information corresponding to one connection node on the forwarding path and the parameter field.

In a specific implementation, that the first connection node records the congestion information in a parameter field corresponding to the first connection node in the first packet includes: the first connection node obtains address information of the first connection node; the first connection node determines, based on the address information of the first connection node and address information in the plurality of segment identifier fields, a segment identifier field corresponding to the first connection node in the first packet; and the first connection node records the congestion information in a parameter field of a segment identifier field corresponding to the first connection node in the first packet.

In a specific implementation, the source node is further configured to: obtain a destination address of a second packet; and plan a forwarding path of the second packet based on locally updated congestion information, to avoid a segment link whose congestion degree is greater than a second preset threshold or a congested link in a planning process.

According to a sixth aspect, an embodiment of this application provides a congestion information collection system. The system includes the apparatus according to the third aspect and the apparatus according to the fourth aspect.

According to a seventh aspect, an embodiment of this application provides a network device, including a processor, a communications interface, and a memory. The memory is configured to store instructions. The processor is configured to execute the instructions. The communications interface is configured to receive or send data. When executing the instructions, the processor performs the method described in any one of the first aspect or the possible implementations of the first aspect.

According to an eighth aspect, an embodiment of this application provides a network device, including a processor, a communications interface, and a memory. The memory is configured to store instructions. The processor is configured to execute the instructions. The communications interface is configured to receive or send data. When executing the instructions, the processor performs the method described in any one of the second aspect or the possible implementations of the second aspect.

According to a ninth aspect, this application provides a computer storage medium, where the computer medium stores a computer program for network fault locating. When the computer program is executed by a processor, the method described in any one of the first aspect or the possible implementations of the first aspect is implemented.

According to a tenth aspect, this application provides a computer storage medium, where the computer medium stores a computer program for network fault locating. When the computer program is executed by a processor, the method described in any one of the second aspect or the possible implementations of the second aspect is implemented.

### BRIEF DESCRIPTION OF DRAWINGS

To describe the technical solutions in the embodiments of the present invention more clearly, the following briefly introduces the accompanying drawings for describing the embodiments. It is clearly that the accompanying drawings in the following description show some embodiments of the present invention, and persons of ordinary skill in the art may still derive other drawings from these accompanying drawings without creative efforts.

FIG. 1 is a schematic diagram of packet transmission according to an embodiment of this application;

FIG. 2 is a schematic diagram depicting a structure of a data center scenario according to an embodiment of this application;

FIG. 3 is a schematic diagram of a segment route extension header SRH according to an embodiment of this application;

FIG. 4 is a schematic diagram of transmitting a packet through SRv6 according to an embodiment of this application;

FIG. 5 is a schematic interaction diagram of a network congestion information collection method according to an embodiment of this application;

FIG. 6 is a schematic diagram of collecting congestion information in a data center scenario according to an embodiment of this application;

FIG. 7 is a schematic diagram depicting a structure of another SRH according to an embodiment of this application;

FIG. 8 is a schematic diagram of collecting congestion information in a wide area network scenario according to an embodiment of this application;

FIG. 9 is a schematic diagram depicting a structure of a congestion information collection apparatus according to an embodiment of this application;

FIG. 10 is a schematic diagram depicting a structure of another congestion information collection apparatus according to an embodiment of this application; and

FIG. 11 is a schematic diagram depicting a structure of a congestion information collection device according to an embodiment of this application.

### DESCRIPTION OF EMBODIMENTS

The following describes in detail the embodiments of this application with reference to accompanying drawings.

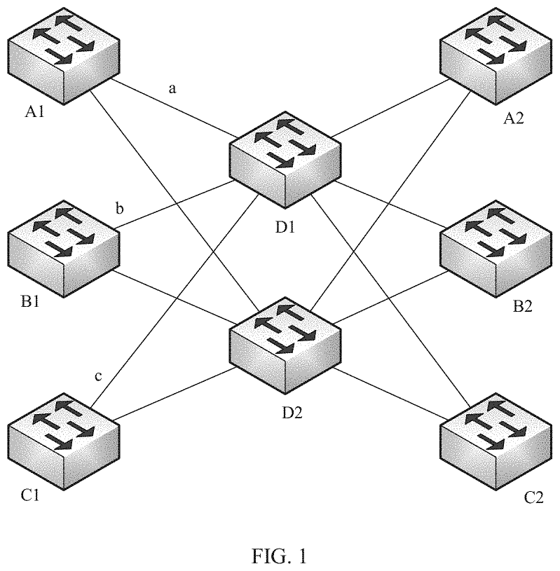

As shown in FIG. 1, a node A1, a node B1, and a node C1 are sending nodes. A packet a is a packet that is sent by the node A1 to a node A2, a packet b is a packet that is sent by the node B1 to a node B2, and a packet c is a packet that is sent by the node C1 to a node C2. The packet a, the packet b, and the packet c all pass through a node D1. If the node D1 is congested, a congested packet is discarded or marked as a congestion packet. After learning that a packet is discarded or a packet is marked, a receiving node feeds back congestion information to a corresponding sending node. For example, when the packet b is marked as a congestion packet, after receiving the packet b, the node B2 feeds back, to the node B1, that congestion occurs during transmission of the packet b. In this case, the node B1 performs congestion control. For example, the node B1 reduces a sending rate or sends a packet to the node B2 through another path.

However, in the foregoing method, because not all packets passing through the node D1 can be marked as congestion packets. For example, if the packet a and the packet c are not marked as congestion packets, the node A1 and the node C1 receive no congestion information. Therefore, the node A1 and the node C1 do not perform congestion control, and still send packets at a rate through a path, where the rate and the path are the same as those used before congestion occurs. Consequently, the node D1 is still congested. In addition, because a node receiving the congestion information cannot determine a specific congested node, after receiving the congestion information, a sending node selects another path to send a packet, and the reselected path may still include the congested node. Consequently, congestion control fails.

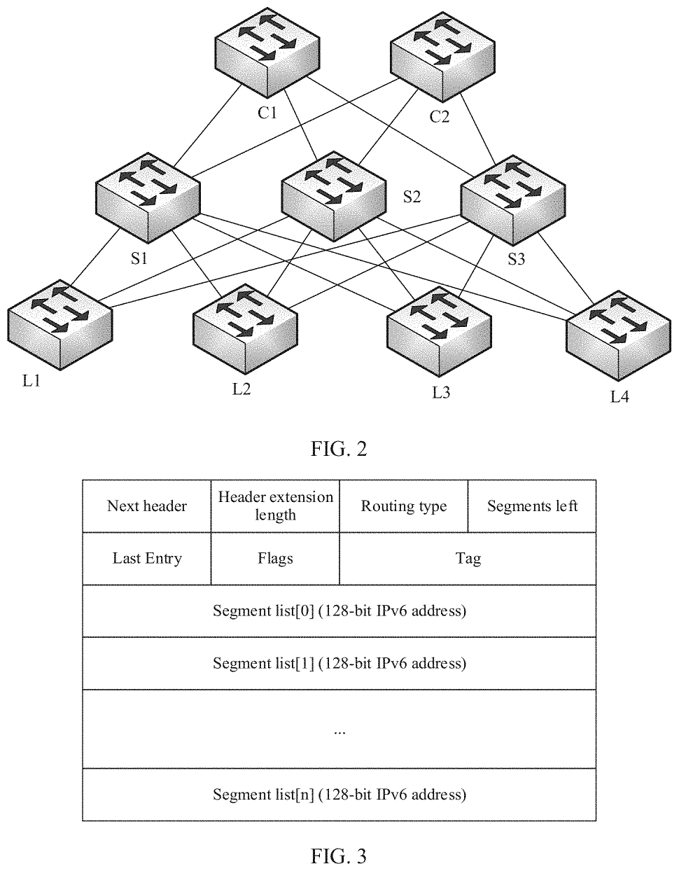

FIG. 2 is a diagram of a network topology in a data center scenario. In FIG. 2, a packet sent by a source node L1 to a target node L4 is encapsulated by using a virtual extensible local area network (virtual extensible local area network, VXLAN) technology, and the packet may be transmitted from the source node L1 to the target node L4 through k links. A CE field is encapsulated into the packet. After the source node L1 determines that a transmission path of the packet is a path 2, the CE field is used to carry a highest congestion degree in the path 2. For example, the path 2 between the source node L1 and the target node L4 includes three nodes: a node S1, a node C1, and a node S2. If a congestion degree between the source node L1 and the node S1 is 2, 2 is written into the CE field. Then, the packet is transmitted to the node C1. If a congestion degree between the node S1 and the node C1 is 1, a value in the CE field remains unchanged. The packet continues to be transmitted to the node S2. If a congestion degree between the node C1 and the node S2 is 3, the node S2 rewrites the value in the CE field to 3. After the target node L4 receives the packet, if a congestion degree between the node S2 and the node L4 is 2, the value in the CE field remains unchanged. The node L4 obtains the congestion degree of the path 2 from the CE field, and updates a congestion information table in the target node L4, where the congestion information table in the node L4 records congestion information of one or more paths whose target node is the node L4. The node L4 sends the congestion degree information in the congestion information table to the source node L1, so that the source node L1 updates a congestion information table in the source node L1. When sending a new packet, the source node L1 can perform congestion load balancing or flow control based on congestion degree information of different transmission paths.

However, in the foregoing method, a source node needs to maintain congestion degree information of each path in a network. In a layer 3 network or a wide area network scenario, a plurality of path states need to be maintained, and congestion information needs to be collected for each path separately. Even if two or more paths overlap, congestion information cannot be shared. As a result, efficiency of collecting congestion information is low.

To resolve the foregoing problem, this application provides a congestion information collection method. Before the method in the embodiments of this application is described, related concepts in the embodiments of this application are first described.

Segment routing (segment routing, SR) is a source-based routing protocol. A basic idea of SR is as follows: A segment identifier (segment identifier, SID) is allocated to each node, a source node specifies a transmission path for a packet that needs to be transmitted, and converts the SIDs of all the nodes on the transmission path into an ordered segment list (segment list) and encapsulates the ordered segment list into a packet header; after receiving the packet, each node on the path only needs to forward the packet based on a path specified by the SID in the segment list. This can simplify data transmission in a network.

Segment routing over IPv6 (segment routing over IPv6, SRv6) is a protocol designed based on source routing for forwarding IPv6 data packets in a network. To implement an SR solution based on an IPv6 forwarding plane, an IPv6 extension header, also referred to as a segment routing header (segment routing header, SRH), is added to an SRv6 packet. To be specific, an IPv6 packet includes an IPv6 standard header, an SRH, and a payload (payload). The source node adds an SRH to each packet. Each SRH carries all SIDs required for forwarding the packet. Each SID is an instantiated IPv6 address and includes a locator (locator) field and a function (function) field. The locator field mainly provides a routing function. The function field indicates any function of a device, for example, a forwarding behavior or a service. In other words, a segment list in the SR corresponds to an IPv6 address list in the SRH. The SRH carries routing information of all transit nodes that the packet needs to pass through. During transmission, a transit node only needs to transmit a packet based on the routing information included in the SRH. A format of the SRH is shown in FIG. 3. For ease of describing a forwarding principle, the SRH may be represented as the following table:

IPv6 Destination Address = Segment List [n]

SRH(Segments Left = n)
< Segment List [0], Segment List [1], Segment List [2],
Segment List [3], . . . , Segment List [n]>

In SRv6, an IPv6 destination address (IPv6 destination address, IPv6 DA) is used to identify an address of a next node on a forwarding path of a packet. A segments left (segments left, SL) field indicates a quantity of nodes that the packet needs to pass through before the packet arrives at a target node. Each time the packet arrives at a node, the IPv6 DA changes to an address of a next node, and a value of the SL field decreases by 1.

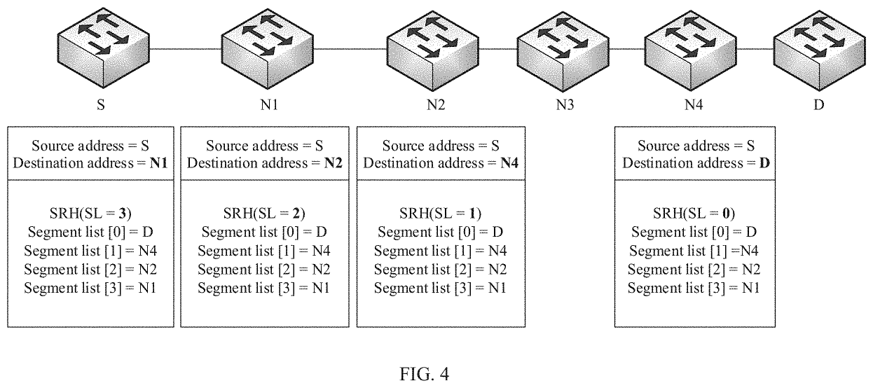

For example, FIG. 4 is a schematic diagram of transmitting a packet through SRv6. A node S sends a packet to a node D. The node S, a node N1, a node N2, a node N4, and a node D have an SRv6 function, but a node N3 does not have an SRv6 function. The node S encapsulates an SRH into the packet. As shown in FIG. 4, on the node S, an IPv6 DA in the packet is an address corresponding to the node N1, and a value of an SL is 3. After receiving the packet, the node N1 determines that the IPv6 DA is an address of the node N1, where SL=3. Then the node N1 decreases the value of the SL by 1, updates the value of the SL to 2, updates the IPv6 DA to an address in a segment list [2] in a segment list, and forwards the packet to the node N2. After receiving the packet, the node N2 determines that the IPv6 DA is an address of the node N2, where SL=2. Then the node N2 decreases the value of the SL by 1, updates the value of the SL to 1, updates the IPv6 DA to an address in a segment list [1] in the segment list, and forwards the packet to the node N3. Because the node N3 does not have the SRv6 function, the node N3 does not process the packet, and transparently transmits the packet to node N4 based on a routing table. After receiving the packet, the node N4 determines that the IPv6 DA is an address of the node N4, where SL=1. Then the node N4 decreases the value of the SL by 1, updates the value of the SL to 0, updates the IPv6 DA to an address in a segment list [0] in the segment list, and forwards the packet to the node D.

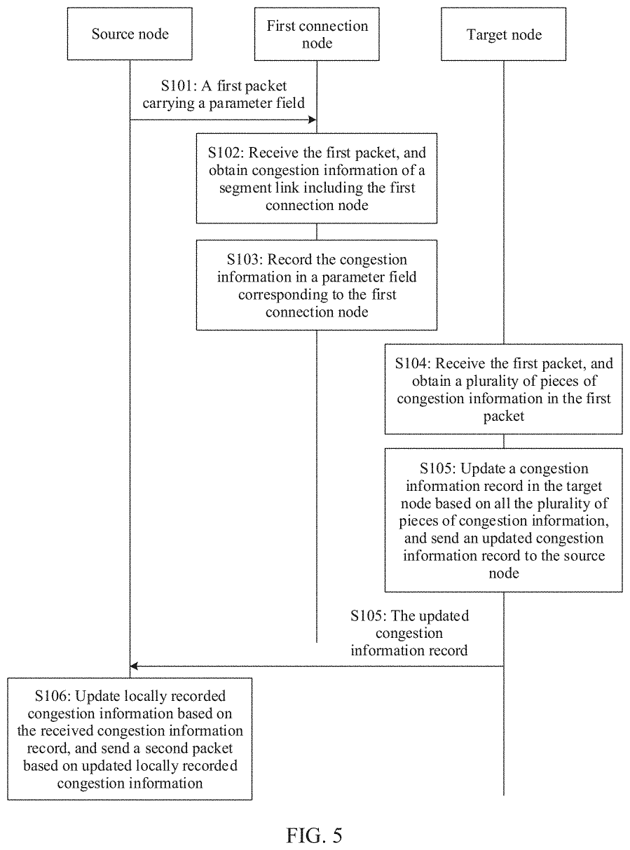

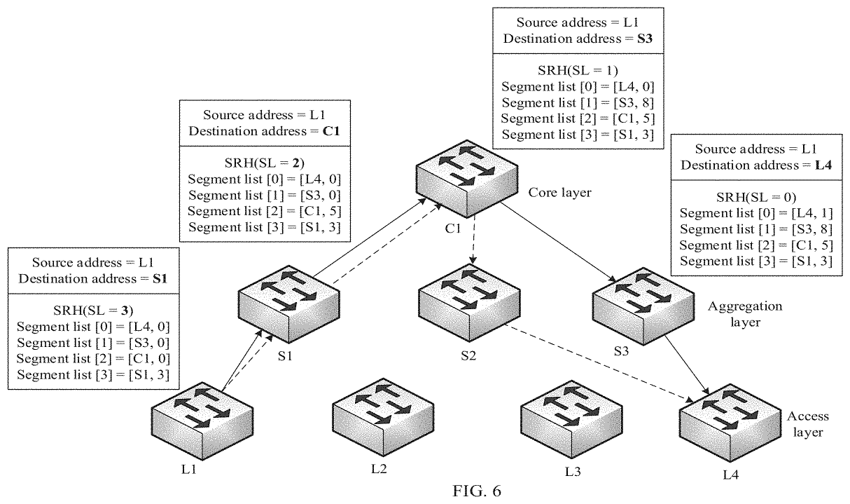

FIG. 5 is a schematic interaction diagram of a network congestion information collection method according to an embodiment of this application. As shown in FIG. 5, the method includes the following steps.

S101: A source node sends a first packet.

In this embodiment of this application, a forwarding path of the first packet includes a plurality of connection nodes. The forwarding path of the first packet is divided by the plurality of connection nodes into a plurality of segment links. The first packet includes a plurality of parameter fields respectively corresponding to the plurality of connection nodes. Each of the plurality of parameter fields is used to record congestion information of a segment link. In a process of forwarding the first packet, any connection node on the forwarding path of the first packet can obtain congestion information of a segment link including the connection node, and records the obtained congestion information in a parameter field corresponding to the connection node. The congestion information includes whether a segment link is congested or a congestion degree of the segment link.

S102: A first connection node receives the first packet, and obtains congestion information of a segment link including the first connection node.

In this embodiment of this application, the first connection node is any one of the plurality of connection nodes. After receiving the first packet, the first connection node obtains the congestion information of the segment link including the first connection node. On the segment link including the first connection node, the first connection node is the 1^{st} node through which the first packet passes on the segment link or the last node through which the first packet passes on the segment link.

In a specific implementation, if each node in a network can collect congestion information of a segment link and write the congestion information into a corresponding parameter field, the first connection node obtains address information of a second connection node, where the second connection node is a next node that the first packet arrives on the forwarding path of the first packet. Then, the first connection node determines, based on the address information of the second connection node, an egress port through which the first packet is sent from the first connection node to the second connection node, obtains a congestion degree of the egress port, and uses the congestion degree as the congestion information. The congestion degree indicates a congestion status of a segment link between the first connection node and the second connection node. Alternatively, after determining the congestion degree of the egress port, the first connection node determines whether the congestion degree is greater than a first preset threshold. If the congestion degree is greater than the first preset threshold, the first connection node determines that the egress port is congested, and uses the information that the egress port is congested as the congestion information of the segment link including the first connection node. If the congestion degree is less than or equal to the first preset threshold, the first connection node determines that the egress port is not congested, and uses the information that the egress port is not congested as the congestion information of the segment link including the first connection node.

In a possible implementation, the congestion degree is represented by a congestion level, and a higher congestion level indicates more severe congestion. The congestion level may be determined based on a queue length of an egress port. For example, when there are 1 to 3 packets waiting to be forwarded through the egress port, it is determined that the congestion level of the egress port is 0; when there are 4 to 6 packets waiting to be forwarded through the egress port, it is determined that the congestion level of the egress port is 1; when there are 7 to 9 packets waiting to be forwarded through the egress port, it is determined that the congestion level of the egress port is 2; and the congestion level of the egress port in other cases can be determined by analogy. It may be understood that the foregoing descriptions are merely examples. There may be another correspondence between a quantity of packets to be forwarded through the egress port and the congestion level. This is not specifically limited in the embodiments of this application.

In a specific implementation, not all nodes in a network have a corresponding parameter field in the first packet, that is, not all nodes can write collected congestion information into the corresponding parameter field. Some nodes in the network may have no corresponding parameter field in the first packet, and such nodes are referred to as common forwarding nodes. For example, in a network such as a wide area network, a forwarding path of a packet includes a large quantity of forwarding nodes. If each of the forwarding nodes collects and records congestion information, a large quantity of empty bytes need to be reserved in the packet for all the forwarding nodes to record congestion information, occupying a large quantity of storage resources and bandwidth resources. Therefore, only some nodes on the forwarding path of the packet on the wide area network are specified to collect and record congestion information. When there is a common forwarding node in the network, after receiving the first packet, the first connection node reads congestion information in a congestion field, and writes the congestion information in the congestion field into a parameter field corresponding to the first connection node. The congestion information in the congestion field is congestion information of a segment link between the first connection node and a third connection node. The third connection node is a connection node located before the first connection node on the forwarding path. There are one or more common forwarding nodes between the first connection node and the third connection node. The congestion information in the congestion field is recorded by a common forwarding node located on the segment link between the third connection node and the first connection node or recorded by the third connection node.

When the congestion information indicates the congestion degree of the segment link, the congestion information in the congestion field is a highest congestion degree between the first connection node and the third connection node. For example, there are two common forwarding nodes N1 and N2 between the third connection node and the first connection node. If the third connection node determines that a congestion degree of a segment link between the third connection node and the common forwarding node N1 is 3, the third connection node writes the congestion degree 3 into a congestion field. After the first packet arrives at the common forwarding node N1, a congestion degree of a segment link between the common forwarding node N1 and the common forwarding node N2 is 2, and the node N1 does not change the value in the congestion field. After the first packet arrives at the common forwarding node N2, the common forwarding node N2 determines that a congestion degree of a segment link between the common forwarding node N2 and the first connection node is 4, and the common forwarding node N2 changes the value in the congestion field to 4. After receiving the first packet, the first connection node obtains the congestion degree 4 in the congestion field, and writes the congestion degree into the parameter field corresponding to the first connection node.

When the congestion information indicates whether the segment link is congested, the first connection node needs to determine, based on a congestion indication identifier in the congestion field, whether the segment link between the first connection node and the third connection node is congested. Specifically, after receiving the first packet, the first connection node obtains a value of the congestion indication identifier. When the value of the congestion indication identifier is 1, the first connection node determines that the segment link is congested between the first connection node and the third connection node. When the value of the congestion indication identifier is 0, the first connection node determines that the segment link is not congested between the first connection node and the third connection node.

There are one or more common forwarding nodes between the first connection node and the third connection node. If one common forwarding node determines that a link is congested between the common forwarding node and a next node after receiving the first packet, the common forwarding node sets the congestion indication identifier to 1. After receiving the first packet, another common forwarding node does not change the congestion indication identifier. In this way, the congestion indication identifier can be used to indicate whether congestion occurs between the first connection node and the third connection node.

In a possible implementation, the congestion indication identifier may be an explicit congestion notification (explicit congestion notification, ECN) flag. When sending the first packet, a sending node that generates the first packet sets the ECN flag to 01 or 10. If any common forwarding node on the forwarding path of the first packet determines that congestion occurs after receiving the first packet, the common forwarding node sets the ECN flag to 11.

S103: The first connection node records the congestion information in the parameter field corresponding to the first connection node in the first packet.

In this embodiment of this application, each connection node has a corresponding parameter field. After obtaining the congestion information of the segment link including the first connection node, the first connection node records the congestion information in the parameter field corresponding to the first connection node in the first packet.

It may be understood that there are a plurality of connection nodes between the sending node and a target node, and the first packet includes a plurality of parameter fields. Therefore, congestion information of a plurality of segment links on the forwarding path of the first packet may be recorded in the first packet. Congestion information in each of the plurality of parameter fields indicates a congestion status of a segment link.

For example, FIG. 6 is a schematic diagram of a network architecture of a data center according to an embodiment of this application. In a layer 3 network architectural diagram in a data center scenario shown in FIG. 6, switches L1 to L4 are access layer switches, switches S1 to S3 are aggregation layer switches, and a switch C1 is a core layer switch. The switch L1 is a source node, and the switch L4 is a target node. The first packet is transmitted to the target node through a path L1-S1-C1-S3-L4. If all nodes in FIG. 6 are connection nodes, that is, all the nodes have respective corresponding parameter fields in the first packet. After the first packet is transmitted to the switch L4, congestion information recorded in the first packet is listed in the following Table 2.

TABLE 2

| Segment link | L1-S1 | S1-C1 | C1-53 | S3-L4 |
|---|---|---|---|---|
| Congestion degree | 3 | 5 | 8 | 1 |

S104: The target node receives the first packet, and obtains a plurality of pieces of congestion information in the first packet.

S105: The target node updates a congestion information record in the target node based on all the plurality of pieces of congestion information, and sends an updated congestion information record to the source node.

The congestion information record records congestion information of one or more segment links in a network in which the target node is located. After receiving the first packet, the target node reads the plurality of pieces of congestion information in the first packet, updates, based on the congestion information that is of each segment link and that is recorded in the first packet, the congestion information record stored in the target node, and sends the updated congestion information record to the source node. That the target node updates the congestion information record includes: The target node adds, to the congestion information record, congestion information of a segment link that is included in the first packet but that is not included in the congestion information record, and updates congestion information of a corresponding segment link in the congestion information record based on the congestion information of each segment link in the first packet. For example, the congestion information record in the target node may be a congestion information table recording congestion information of a segment link. If a congestion degree of a link “L1-S1” in the congestion information table is 5, and congestion information of a link “C1-S3” is 4, after receiving the first packet, the target node updates the congestion degree of the link “L1-S1” to 3, and updates the congestion information of the link “C1-S3” to 8.

S106: The source node receives the updated congestion information record sent by the target node, and updates locally recorded congestion information based on the received congestion information record.

After receiving the congestion information record sent by the target node, the source node updates, based on the congestion information of each segment link in the congestion information record, the congestion information locally recorded by the source node, so that the source node plans a forwarding path of a second packet based on the updated locally recorded congestion information before sending the second packet next time, to avoid a congested link in the locally recorded congestion information or avoid a link whose congestion degree is greater than a second preset threshold. Alternatively, when the forwarding path of the second packet includes a congested link or includes a link whose congestion degree is greater than the second preset threshold, the source node informs a node that generates a packet to reduce a packet sending rate.

The scenario shown in FIG. 6 is still used as an example. The node L1 is a source node. After the node L1 updates the locally recorded congestion information, if the L1 further needs to send the second packet to the node L4, the node L1 may plan the transmission path of the second packet based on the updated locally recorded congestion information. Because the congestion degree of the link “C1-S3” is 8, congestion is severe, when planning the transmission path, the node L1 prevents the second packet from passing through the link “C1-S3”. As shown by dashed lines in FIG. 6, a finally planned transmission path is “L1-S1-C1-S2-L4”. If the transmission path “L1-S1-C1-S2-L4” also includes a congested segment link, the source node may inform a node that generates the second packet to reduce a packet sending rate.

Each segment link on the forwarding path of the first packet may also be a segment link on another forwarding path. For example, in FIG. 6, the first packet is transmitted to the target node L4 through a path “L1-S1-C1-S3-L4”, where the segment link “C1-S3” may also be a segment link of a path “L1-S1-C1-S3-L3” through which a packet whose target node is a node L3 passes. Therefore, after congestion information obtained by a target node is fed back to a source node, the congestion information may be used by the source node to plan a transmission path of a packet when the source node sends a packet to another target node.

According to the congestion information collection method provided in this application, a plurality of parameter fields that can be used to record congestion information are encapsulated into a packet, so that congestion information of a plurality of segment links on a transmission path of a packet can be recorded during transmission of the packet, instead that only one piece of congestion information is recorded for one forwarding path. Then, a target node can feed back, to a source node, the congestion information of the plurality of segment links recorded in the packet, so that the source node can maintain a file that records the congestion information of the plurality of segment links in a network. When sending a new packet, the source node can plan a transmission path of the new packet based on congestion information of each segment link. This can avoid the following case in which a specific location where congestion occurs cannot be located when a network congestion status is recorded based on the entire transmission path, and consequently the new packet cannot bypass the congested location. Alternatively, when determining that a forwarding path of the new packet that needs to be sent includes a congested link, the source node informs a node that generates the packet to reduce a packet sending rate.

In a specific implementation, the first packet includes one or more segment identifier fields. Each segment identifier field includes address information of a node and a parameter field corresponding to the node, and the address information is used to determine a parameter field corresponding to any connection node on the forwarding path of the first packet. For example, after receiving the first packet, the first connection node first determines that first address information in the one or more segment identifier fields is the same as an address of the first connection node, and the first connection node determines that a first segment identifier field corresponding to the first address information is a segment identifier field corresponding to the first connection node. The first connection node obtains the congestion information of the segment link including the first connection node, and writes the congestion information into a parameter field corresponding to the first segment identifier field.

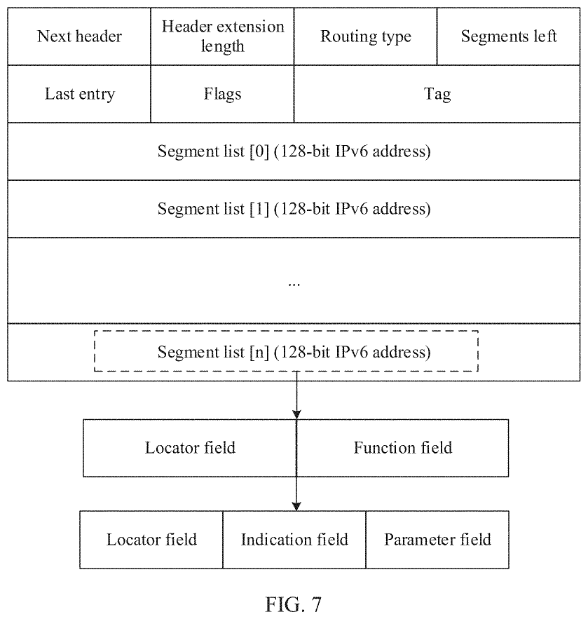

In a specific implementation, the segment identifier field may be a SID in an SRH. Before sending the first packet based on an SRv6 protocol, the source node divides a function field in each SID field in the SRH into an indication field and a parameter field, where the indication field carries indication information. FIG. 7 is a schematic diagram depicting a structure of another SRH according to an embodiment of this application. After receiving the first packet, the first connection node first obtains a value of an SL field in the SRH, determines, based on the value of the SL field, a segment list field corresponding to the first connection node, reads address information from the segment list field, determines a next DA of the first packet, and determines an egress port of the first packet based on the next DA. Then the first connection node writes collected congestion information of the egress port into a parameter field in the segment list field, and sends the first packet to the next node through the egress port.

For example, as shown in FIG. 6, before the source node L1 forwards the first packet, the source node L1 encapsulates an SRH into the first packet, where the SRH includes four SIDs in total: a segment list [0] to a segment list [3]. Address information in the four SIDs respectively corresponds to addresses of four nodes: S1, C1 , S3, and L4. In this case, an address of a DA in the SRH is an address of S1, a value of SL is 3. The node L1 determines a target egress port of the first packet, and obtains that a congestion degree of the target egress port is 3, that is, a congestion degree of the link “L1-S1” is 3. The node L1 writes the congestion degree into a parameter field of the segment list [3], and sends the first packet.

The node S1 receives the first packet. Before updating the DA and the value of the SL in the SRH, the node S1 obtains the DA and the value (SL=3) of the SL in the SRH. If the node S1 determines that the obtained address of the DA is the same as the address of the node S1, the node S1 decreases the value of the SL by 1, and updates the value of the SL to 2. The node S1 determines that the congestion degree of the egress port needs to be written into a parameter field of the segment list [2]. The node S1 determines that a next DA of the first packet is an address in the segment list [2], determines a target egress port of the first packet based on the address in the segment list [2], and determines that a congestion degree of the target egress port is 5, indicating that a congestion degree of a link “S1-C1” is 5. Then, the node S1 writes the congestion degree of the target egress port into the parameter field in the segment list [2]. After writing the congestion degree into the corresponding parameter field, the node S1 updates the DA in the SRH to the address in the segment list [2], and then sends the first packet.

After receiving the first packet, the node C1 determines an egress port of the first packet according to a processing method same as the processing method executed by the node S1, and obtains a congestion degree of the egress port, that is, obtains a congestion degree indicating a congestion degree of a link “C1-S3”. The node C1 writes the congestion degree of the egress port into a parameter field in the segment list [1]. The procedure continues by analogy until the node S3 writes a congestion degree of a link “S3-L4” into a parameter field in the segment list [0].

It may be understood that, after receiving the first packet, the first connection node may collect a congestion degree of each egress port or a congestion degree of a target egress port. Alternatively, the first connection node may determine and update congestion degrees of a plurality of egress ports every preset period, and after receiving the first packet, the first connection node obtains a congestion degree of a target egress port corresponding to the first packet as congestion information. This is not specifically limited in this embodiment of this application.

In the foregoing specific implementations, each node can collect its own congestion information and write the congestion information into a parameter field corresponding to each node. This method is applicable to a scenario, for example, the data center scenario, in which a network topology is simple and a forwarding path of a packet includes a small quantity of nodes. For a network such as a wide area network, if a corresponding segment identifier field is configured for each node, and each node can collect its own congestion information and write the congestion information into a corresponding parameter field of each node, a large amount of SRH data needs to be encapsulated in each packet. In addition, each source node also needs to maintain a large amount of congestion information. Therefore, the method in the foregoing embodiment is not applicable to the network such as the wide area network.

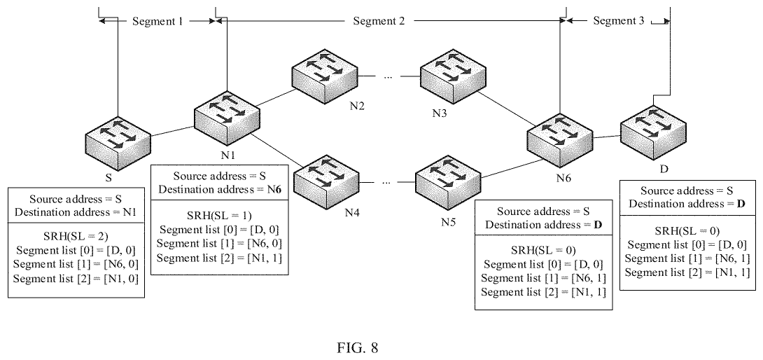

In a specific implementation, for the network such as the wide area network, information about some nodes that a packet needs to pass through may be encapsulated into an SRH. As shown in FIG. 8, a source node S needs to transmit a first packet to a target node D through a path on which a node N2 and a node N3 are located. Because there are a large quantity of nodes between the node N2 and the node N3, only SRH information of a node N1, a node N6, and a node D is encapsulated into the first packet. In this way, an entire forwarding path of the first packet is divided into three segment links: “S-N1”, “N1-N6”, and “N6-D”.

This embodiment of this application is described by using an example in which congestion information indicates whether a segment link is congested, and an ECN flag is used as a congestion field to record whether the segment link is congested is used for description. The node S encapsulates the SRH into the first packet, and sets an initial value of the ECN flag to 01. A value of the ECN flag being 01 indicates that a link is not congested, and a value of the ECN flag being 11 indicates that the link is congested. Then, the node S determines an egress port of the first packet, and obtains a congestion degree of the egress port. When the congestion degree is greater than a first preset threshold, the node S determines that the egress port is congested, changes a value of the ECN flag to 11 to indicate that congestion occurs on a segment link between the node S and the node N1, and sends the first packet to the node N1.

After receiving the first packet and before changing a DA in the first packet, the node N1 obtains a current DA of the first packet and a current value (SL=2) of SL of the first packet. If the node N1 determines that the current DA is the same as an address of the node N1, the node N1 reads a value of the ECN flag. Because the value of the ECN flag is 11, the node N1 determines that the segment link “S-N1” is congested. The node N1 sets a value of a parameter field in a segment list [2] to 1, indicating that the link “S-N1” is congested; decreases the value of the SL by 1, that is, updates the value of the SL to 1; uses an address in a segment list [1] as a new DA; and updates the current DA to an address of the node N6. Then, the node N1 determines a next egress port of the first packet, and obtains a congestion degree of the egress port. If the congestion degree is less than or equal to the first preset threshold, the node N1 determines that the egress port is not congested, changes a value of the ECN flag to 01, and sends the first packet.

After receiving the first packet, the node N2 obtains a current DA, and determines whether the current DA is the same as an address of the node N2. When the node N2 determines that the current DA is different from the address of the node N2, that is, the node N2 is a common forwarding node, the node N2 determines an egress port of the first packet by searching a routing table, and determines whether the egress port is congested. When determining that the egress port is congested, the node N2 reads a value of the ECN. Because the value of the ECN is 01, the node N2 changes the value of the ECN to 11. When determining that the egress port is not congested, the node N2 does not change the value of the ECN. To be specific, when the node N2 and a common forwarding node following the node N2 determine that an egress port connected to a next forwarding node is not congested, regardless of whether the value of the ECN is 01 or 11, the node N2 and the common forwarding node following the node N2 do not change the value of the ECN. When the node N2 and the common forwarding node following the node N2 determine that the egress port connected to the next node is congested, if the value of the ECN flag is 01, the node N2 and the common forwarding node following the node N2 change the value of the ECN flag to 11. If the value of the ECN flag is 11, the node N2 and the common forwarding node following the node N2 do not change the value of the ECN flag.

After receiving the first packet, the node N6 obtains a current DA of the first packet and a current value (SL=1) of the SL of the first packet. If the node N6 determines that the current DA is the same as an address of the node N6, the node N6 reads a value of the ECN flag. If the value of the ECN flag is 11, the node N6 determines that the segment link “N1-N6” is congested, and sets a value of a parameter field in a segment list [1] to 1, indicating that the link “N1-N6” is congested. Then, the node N6 decreases the value of the SL by 1, that is, the node N6 updates the value of the SL to 0; uses an address in a segment list [0] as a new DA; and updates a current DA to an address of the node D. Then, the node N6 determines a next egress port of the first packet, and obtains a congestion degree of the egress port. When the node N6 determines that the congestion degree is less than or equal to the first preset threshold, the node N6 determines that the egress port is not congested, and the node N6 changes the value of the ECN flag to 01 and sends the first packet.

After receiving the first packet, the target node D obtains a current DA of the first packet and a current value (SL=0) of the SL of the first packet. If the target node D determines that the current DA is the same as the address of the node D, the target node D reads a value of the ECN flag. Because the value of the ECN flag is 01, the target node D determines that the segment link “N6-D” is not congested, and sets a value of a parameter field in a segment list [0] to 0, indicating that the link “N6-D” is not congested.

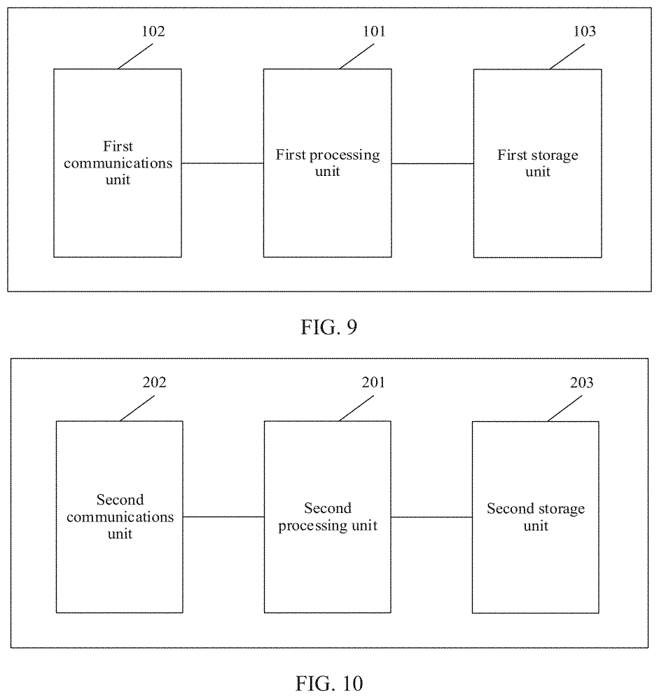

With reference to FIG. 1 to FIG. 8 and the method embodiments, the following describes related network apparatuses in the embodiments of this application. FIG. 9 is a schematic diagram depicting a structure of a congestion information collection apparatus according to an embodiment of this application. The congestion information collection apparatus 100 includes a first processing unit 101 and a first communications unit 102.

The first communications unit 102 is configured to receive a first packet.

The first processing unit 101 is configured to obtain congestion information of a segment link including a first connection node, and record the congestion information in a parameter field corresponding to the first connection node in the first packet.

The first communications unit 102 is further configured to forward the first packet into which the congestion information is written.

Specifically, the first processing unit 101 is configured to control and manage actions of the apparatus 100. For example, the first processing unit 101 is configured to perform S102 and S103 in FIG. 5, and/or is configured to perform operations performed by the first connection node in the method embodiments of this application. The first communications unit 102 is configured to receive a packet sent by another apparatus or send a packet to another apparatus.

The congestion information collection apparatus further includes a first storage unit 103. The first storage unit 103 stores program code and data. For example, the first storage unit 103 is configured to buffer a to-be-sent packet when an egress port of the apparatus is congested.

Specifically, for specific implementation of various operations performed by the apparatus 100, refer to specific operations performed by the first connection node in the foregoing method embodiments. Details are not described herein again.

FIG. 10 is a schematic diagram depicting a structure of another congestion information collection apparatus according to an embodiment of this application. A congestion information collection apparatus 200 includes a second processing unit 201 and a second communications unit 202.

The second communications unit 202 is configured to send a first packet to a target node.

The second communications unit 202 is further configured to receive a congestion information record, where the congestion information record is sent by the target node after receiving the first packet, and the congestion information record includes congestion information that is of each segment link and that is recorded in the first packet.

The second processing unit 201 updates locally recorded congestion information based on the received congestion information record.

The second communications unit 202 is further configured to send a second packet based on updated locally recorded congestion information.

Specifically, the second processing unit 201 is configured to control and manage actions of the apparatus 200. For example, the second processing unit 201 is configured to perform S101 and S106 in FIG. 5, and/or is configured to perform operations performed by the source node in the method embodiments of this application. The second communications unit 202 is configured to receive a packet sent by another apparatus or send a packet to another apparatus.

The congestion information collection apparatus further includes a second storage unit 203. The second storage unit 203 stores program code and data. For example, the second storage unit 203 is configured to store the congestion information.

Specifically, for specific implementation of various operations performed by the apparatus 200, refer to specific operations performed by the source node in the foregoing method embodiments. Details are not described herein again.

The processing unit 201 may be a processor or a controller, such as a central processing unit (central processing unit, CPU), a general-purpose processor, a digital signal processor (digital signal processing, DSP), an application-specific integrated circuit (application-specific integrated circuit, ASIC), a field programmable gate array (field programmable gate array, FPGA), or another programmable logic device, a transistor logic device, a hardware component, or any combination thereof. The processor may implement or execute various example logical blocks, modules, and circuits described with reference to content disclosed in this application. Alternatively, the processor may be a combination of processors implementing a computing function, for example, a combination of one or more microprocessors, or a combination of the DSP and a microprocessor. The second communications unit 102 and the second communications unit 202 each may be a communications interface, a transceiver, a transceiver circuit, or the like. The communications interface is an umbrella term and may include one or more interfaces. The second storage unit 103 and the second storage unit 203 each may be a memory, or another module configured to provide a storage function or service.

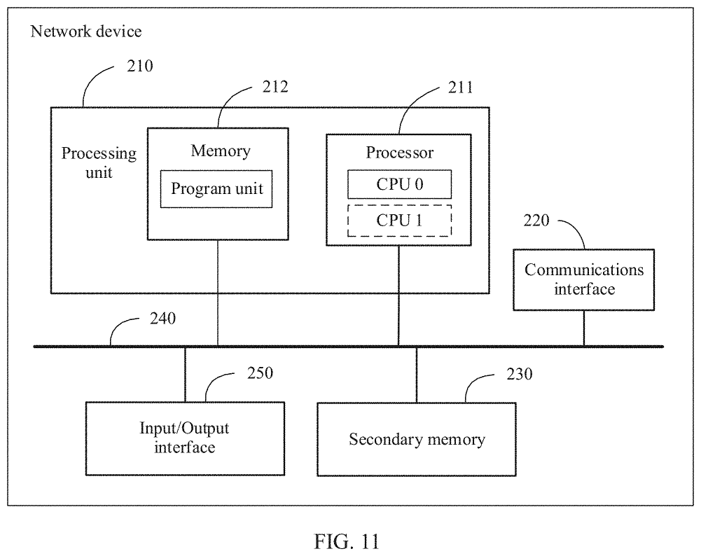

FIG. 11 is a schematic diagram depicting a structure of a congestion information collection device according to an embodiment of this application, where the congestion information collection may be a network device. The network device 300 includes at least a processing unit 210, and a communications interface 220. The processing unit 210, the communications interface 220, and a memory 230 are connected through a bus 240.

When the network device performs functions of a first connection node in the foregoing method embodiments, the communications interface 220 is configured to receive a first packet. The processing unit 210 is configured to obtain congestion information of a segment link including the first connection node, and record the congestion information in a parameter field corresponding to the first connection node in the first packet. The communications interface 220 is further configured to forward the first packet into which the congestion information is written.

Specifically, the processing unit 210 is configured to control and manage actions of the network device 300. For example, the processing unit 210 is configured to perform S102 and S103 in FIG. 5, and/or is configured to perform operations performed by the first connection node in the method embodiments of this application. The communications interface 220 is configured to receive a packet sent by another apparatus or send a packet to another apparatus. For example, the communications interface 220 receives the first packet and forwards the first packet into which the congestion information is written.

When the network device performs functions of a source node in the foregoing method embodiments, the communications interface 220 is configured to send a first packet to a target node. The communications interface 220 is further configured to receive a congestion information record, where the congestion information record is sent by the target node after receiving the first packet, and the congestion information record includes congestion information that is of each segment link and that is recorded in the first packet. The processing unit 210 updates locally recorded congestion information based on the received congestion information record. The communications interface 220 is further configured to send a second packet based on updated locally recorded congestion information.

Specifically, the processing unit 210 is configured to control and manage actions of the network device. For example, the processing unit 210 is configured to perform S101 and S106 in FIG. 5, and/or is configured to perform operations performed by the source node in the method embodiments of this application. The communications interface 220 is configured to receive a packet sent by another apparatus or send a packet to another apparatus.

The processing unit 210 may have a plurality of specific implementation forms. For example, the processing unit 210 may include a processor 211 and a storage unit. The storage unit may be a memory 212. The processor 211 performs a related operation based on a program unit stored in the memory 212. The program unit may be instructions, or referred to as computer instructions. The processor 211 may be a CPU or a graphics processing unit (graphics processing unit, GPU), and the processor 211 may be a single-core processor or a multi-core processor. The processor 211 may include a combination of a CPU and a hardware chip. The hardware chip may be an ASIC, a programmable logic device (programmable logic device, PLD), or a combination of the ASIC and the PLD. The PLD may be a complex programmable logic device (complex programmable logic device, CPLD), a field programmable logic gate array (FPGA), a generic array logic (generic array logic, GAL), or any combination thereof. Alternatively, the processor 211 may be individually implemented by using a logic device with built-in processing logic, for example, an FPGA or a DSP.

The communications interface 220 may be a wired interface (for example, an Ethernet interface) or a wireless interface (for example, a cellular network interface or a wireless local area network interface), and is configured to communicate with another module or device. Optionally, the network device may further include an input/output interface 250. The input/output interface 250 is connected to an input/output device, and is configured to receive input information and output an operation result. The input/output interface 250 may be a mouse, a keyboard, a display, a CD-ROM drive, or the like.

The bus 240 may be a peripheral component interconnect (Peripheral Component Interconnect, PCI) bus, an extended industry standard architecture (Extended Industry Standard Architecture, EISA) bus, and or the like. The bus 240 may be classified into an address bus, a data bus, a control bus, and the like. For ease of representation, only one thick line is used to represent the bus in FIG. 11, but this does not mean that there is only one bus or only one type of bus.

Optionally, the network device may further include a secondary memory 230, which is generally referred to as an external memory. A storage medium of the secondary memory 230 may be a magnetic medium (for example, a floppy disk, a hard disk, or a magnetic tape), an optical medium (for example, an optical disc), a semiconductor medium (for example, a solid-state drive), or the like. The secondary memory 230 may also be configured to store program code and data, so that the processor 210 invokes the program code and the data stored in the secondary memory 230 to implement functions of the communications module and/or the processing module. In addition, the network device may include more or fewer components than those shown in FIG. 11, or may have different component configuration.

Specifically, for specific implementation of various operations performed by the network device 300, refer to specific operations performed by the first connection node or a source node in the foregoing method embodiments. Details are not described herein again.

The embodiments of the present invention further provide a computer storage medium. The computer storage medium stores instructions. When the instructions are run on a processor, the method steps in the foregoing method embodiments may be implemented. For specific implementation of performing the method steps by the processor corresponding to the computer storage medium, refer to specific operations in the foregoing method embodiments. Details are not described herein again.

All or some of the foregoing embodiments may be implemented by using software, hardware, or any combination thereof. When software is used to implement the embodiments, the embodiments may be implemented completely or partially in a form of a computer program product. The computer program product includes one or more computer instructions. When the computer program instructions are loaded and executed on the computer, the procedure or functions according to the embodiments of this application are all or partially generated. The computer may be a general-purpose computer, a dedicated computer, a computer network, or other programmable apparatuses. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a DVD), or a semiconductor medium (for example, an SSD).

The steps in the methods embodiments of this application may be adjusted in sequence, combined, or deleted based on actual requirements. Modules in the apparatus embodiments of this application may be divided, combined, or deleted based on actual requirements.

The embodiments of this application are described in detail above. The principle and implementation of this application are described herein by using specific examples. The description about the embodiments of this application is merely provided to help understand the method and core ideas of this application. In addition, persons of ordinary skill in the art can make variations and modifications to this application in terms of the specific implementations and application scopes according to the ideas of this application. Therefore, the content of this specification shall not be construed as any limit on this application.

What is claimed is:

1. A congestion information collection method, comprising:
receiving, by a first connection node, a first packet, wherein a forwarding path of the first packet comprises a plurality of connection nodes, the forwarding path is divided by the plurality of connection nodes into a plurality of segment links, the first connection node is any one of the plurality of connection nodes, the first packet comprises a plurality of parameter fields respectively corresponding to the plurality of connection nodes, and each of the plurality of parameter fields is used to record congestion information of a segment link;
obtaining, by the first connection node, congestion information of a segment link comprising the first connection node; and
recording, by the first connection node, the congestion information in a parameter field corresponding to the first connection node in the first packet.

2. The method according to claim 1, wherein the segment link comprising the first connection node is a segment link between the first connection node and a next connection node on the forwarding path of the first packet, and the obtaining congestion information of a segment link comprising the first connection node comprises:
obtaining, by the first connection node, address information of a second connection node, wherein the second connection node is a next connection node on the forwarding path of the first packet;
determining, by the first connection node based on the address information of the second connection node, an egress port through which the first connection node forwards the first packet; and
obtaining, by the first connection node, a congestion degree of the egress port, and using the congestion degree as the congestion information of the segment link comprising the first connection node.

3. The method according to claim 2, wherein the obtaining, by the first connection node, a congestion degree of the egress port, and using the congestion degree as the congestion information of the segment link comprising the first connection node comprises:
obtaining, by the first connection node, the congestion degree of the egress port; and
when the congestion degree of the egress port is greater than a first preset threshold, determining, by the first connection node, that a link is congested between the first connection node and the second connection node, and using the information that the link is congested between the first connection node and the second connection node as the congestion information; or
when the congestion degree of the egress port is less than or equal to the first preset threshold, determining, by the first connection node, that a link is not congested between the first connection node and the second connection node, and using the information that the link is not congested between the first connection node and the second connection node congestion information as the congestion information.

4. The method according to claim 1, wherein the segment link comprising the first connection node is a segment link between the first connection node and a previous connection node on the forwarding path of the first packet, and the obtaining congestion information of a segment link comprising the first connection node comprises:
obtaining, by the first connection node, congestion information in a congestion field, wherein the congestion information in the congestion field indicates a congestion status of a link between the first connection node and a third connection node, the third connection node is a previous connection node on the forwarding path, and the congestion information in the congestion field is recorded by a forwarding node located on a segment link between the third connection node and the first connection node or recorded by the third connection node; and
using the congestion information in the congestion field as the congestion information of the segment link.

5. The method according to claim 4, wherein after the obtaining, by the first connection node, congestion information in a congestion field, the method further comprises:
obtaining, by the first connection node, address information of a next node on the forwarding path of the first packet;
determining, by the first connection node based on the address information of the next node, an egress port through which the first connection node forwards the first packet; and
obtaining, by the first connection node, a congestion degree of the egress port, and recording the congestion degree in the congestion field.

6. The method according to claim 1, wherein the first packet comprises a plurality of segment identifier fields, and each of the plurality of segment identifier fields comprises address information and a parameter field that are corresponding to a connection node on the forwarding path.

7. A congestion information collection method, comprising:
sending, by a source node, a first packet to a target node, wherein a forwarding path of the first packet comprises a plurality of connection nodes, the forwarding path is divided by the plurality of connection nodes into a plurality of segment links, the first packet comprises a plurality of parameter fields, each of the plurality of parameter fields is used to record congestion information of a segment link, and the congestion information is recorded by a connection node on the forwarding path in a process of forwarding the first packet;
receiving, by the source node, a congestion information record, wherein the congestion information record is sent by the target node after receiving the first packet, and the congestion information record comprises congestion information that is of each segment link and that is recorded in the first packet; and
updating, by the source node, locally recorded congestion information based on the received congestion information record.

8. The method according to claim 7, wherein the method further comprises:
obtaining, by the source node, a destination address of a second packet; and
planning, by the source node, a forwarding path of the second packet based on locally updated congestion information, to avoid a segment link whose congestion degree is greater than a second preset threshold or a congested link in a planning process.

9. The method according to claim 7, wherein before the sending, by a source node, a first packet to a target node, the method further comprises:
encapsulating, by the source node, a plurality of segment identifier fields into the first packet, wherein each of the plurality of segment identifier fields comprises address information corresponding to one connection node on the forwarding path and the parameter field.

10. A congestion information collection apparatus, wherein the apparatus comprises: a processor and a memory, wherein the memory is configured to store instructions, and the processor is configured to execute the instructions to cause the congestion information collection apparatus to:
receive a first packet, wherein a forwarding path of the first packet comprises a plurality of connection nodes, the forwarding path is divided by the plurality of connection nodes into a plurality of segment links, the congestion information collection apparatus is any one of the plurality of connection nodes, the first packet comprises a plurality of parameter fields respectively corresponding to the plurality of connection nodes, and each of the plurality of parameter fields is used to record congestion information of a segment link; and
obtain congestion information of a segment link comprising the congestion information collection apparatus, and record the congestion information in a parameter field corresponding to the congestion information collection apparatus in the first packet.

11. The apparatus according to claim 10, wherein the segment link comprising the congestion information collection apparatus is a segment link between the congestion information collection apparatus and a next connection node on the forwarding path of the first packet, and the congestion information collection apparatus is further caused to:
obtain address information of a second connection node, wherein the second connection node is a next connection node on the forwarding path of the first packet;
determine, based on the address information of the second connection node, an egress port through which the congestion information collection apparatus forwards the first packet; and
obtain a congestion degree of the egress port, and use the congestion degree as the congestion information of the segment link comprising the congestion information collection apparatus.

12. The apparatus according to claim 11, wherein the congestion information collection apparatus is further caused to:
obtain the congestion degree of the egress port; and
when the congestion degree of the egress port is greater than a first preset threshold, determine that a link is congested between the congestion information collection apparatus and the second connection node, and use the information that the link is congested between the congestion information collection apparatus and the second connection node as the congestion information; or
when the congestion degree of the egress port is less than or equal to the first preset threshold, determine that the link is not congested between the congestion information collection apparatus and the second connection node, and use the information that the link is not congested between the congestion information collection apparatus and the second connection node as the congestion information.

13. The apparatus according to claim 10, wherein the segment link comprising the congestion information collection apparatus is a segment link between the congestion information collection apparatus and a previous connection node on the forwarding path of the first packet, and the congestion information collection apparatus is further caused to:
obtain congestion information in a congestion field, wherein the congestion information in the congestion field indicates a congestion status of a link between the congestion information collection apparatus and a third connection node, the third connection node is a previous connection node on the forwarding path, and the congestion information in the congestion field is recorded by a forwarding node located on a segment link between the third connection node and the congestion information collection apparatus or recorded by the third connection node; and
use the congestion information in the congestion field as the congestion information of the segment link.

14. The apparatus according to claim 13, wherein after the obtaining, by the first connection node, congestion information in a congestion field, the congestion information collection apparatus is further caused to:
obtain address information of a next node on the forwarding path of the first packet;
determine, based on the address information of the next node, an egress port through which the congestion information collection apparatus forwards the first packet; and
obtain a congestion degree of the egress port, and record the congestion degree in the congestion field.

15. The apparatus according to claim 14, wherein the congestion information collection apparatus is further caused to:
obtain the congestion degree of the egress port; and when the congestion degree is greater than a first preset threshold, determine that a link is congested between the congestion information collection apparatus and the next node, and record the information that the link is congested between the congestion information collection apparatus and the next node in the congestion field; or
obtain the congestion degree of the egress port; and when the congestion degree is less than or equal to the first preset threshold, determine that the link is not congested between the congestion information collection apparatus and the next node, and record the information that the link is not congested between the congestion information collection apparatus and the next node in the congestion field.

16. The apparatus according to claim 10, wherein the first packet comprises a plurality of segment identifier fields, and each of the plurality of segment identifier fields comprises address information and a parameter field that are corresponding to a connection node on the forwarding path.

17. The apparatus according to claim 16, wherein the congestion information collection apparatus is further caused to:
obtain address information of the congestion information collection apparatus;
determine, based on the address information of the congestion information collection apparatus and address information in the plurality of segment identifier fields, a segment identifier field corresponding to the congestion information collection apparatus in the first packet; and
record the congestion information in a parameter field of the segment identifier field corresponding to the congestion information collection apparatus in the first packet.

18. A congestion information collection apparatus, wherein the apparatus comprises: a processor and a memory, wherein the memory is configured to store instructions, and the processor is configured to execute the instructions to cause the congestion information collection apparatus to:
send a first packet to a target node, wherein a forwarding path of the first packet comprises a plurality of connection nodes, the forwarding path is divided by the plurality of connection nodes into a plurality of segment links, the first packet comprises a plurality of parameter fields, each of the plurality of parameter fields is used to record congestion information of a segment link, and the congestion information is recorded by a connection node on the forwarding path in a process of forwarding the first packet, wherein
receive a congestion information record, wherein the congestion information record is sent by the target node after receiving the first packet, and the congestion information record comprises congestion information that is of each segment link and that is recorded in the first packet; and
update locally recorded congestion information based on the received congestion information record.

19. The apparatus according to claim 18, wherein the congestion information collection apparatus is further caused to:
obtain a destination address of a second packet; and
plan a forwarding path of the second packet based on locally updated congestion information, to avoid a segment link whose congestion degree is greater than a second preset threshold or a congested link in a planning process.

20. The apparatus according to claim 19, wherein before the communications unit sends the first packet to the target node, the congestion information collection apparatus is further caused to:
encapsulate a plurality of segment identifier fields into the first packet, wherein each of the plurality of segment identifier fields comprises address information corresponding to one connection node on the forwarding path and the parameter field.
